(19) United States
(12) Patent Application Publication
(10) Pub. No.: US 2009/0144699 A1
(43) Pub. Date: Jun. 4, 2009

(54) LOG FILE ANALYSIS AND EVALUATION TOOL

(76) Inventors: Anton Fendt, Erlengen (DE); Klaus Loehel, Nuernberg (DE); Stefan Poehnlein, Erlengen (DE)

Correspondence Address: SCHIFF HARDIN, LLP;PATENT DEPARTMENT, 6600 SEARS TOWER, CHICAGO, IL, 60606-6473, US

(21) Appl. No.: 11/948,027

(22) Filed: Nov. 30, 2007

(51) Int. Cl. G06F 9/44

(52) U.S. Cl. 717/120

(57) ABSTRACT

A method is provided for automatically evaluating a log file of a software module. Prior to an execution of a first version of a software module, the method comprises evaluating all possible messages or events that can occur in a log file of the first version of the software module, and establishing the messages or events as evaluation criteria. Then, during execution of the first version of the software module, generating a log file comprising a plurality of message or events from the software module. Finally, after generation of the log file, the method comprises transferring the log file to an analysis system, automatically evaluating the plurality of messages or events in the transferred log file according to the previously established evaluation criteria, thereby creating relevant developer error information, automatically informing developers about the relevant developer error information. This information is used to further improve the software.

### BACKGROUND

The present invention is directed to a system and appertaining method for systematically evaluating and analyzing messages of log files and used as evaluation criteria in the development phase of a system software product, particularly as applied to the field of medical imaging.

Historically, log file data has been analyzed manually with text editors and using keyword searches. Random sample-like evaluations and a calculation of quality indices would be conducted in a general purpose tool, such as Microsoft Excel.®

### SUMMARY

The present invention, according to various embodiments, provides an automated mechanism for analyzing and evaluating information obtained from log files. These embodiments permit the comparison of quality statistics for different software versions of a module or system, and permit a monitoring of installed bases worldwide. Graphical overviews can be generated, as can a detailed analysis of any problems that have occurred.

Accordingly, a method is provided for automatically evaluating a log file of a software module, comprising: prior to an execution of a first version of a software module: evaluating all possible messages or events that can occur in a log file of the first version of the software module; and establishing the messages or events as evaluation criteria for a further development phase of the software module; during execution of the first version of the software module: generating a log file comprising a plurality of message or events from the software module; and after generation of the log file: transferring the log file to an analysis system; automatically evaluating the plurality of messages or events in the transferred log file according to the previously established evaluation criteria, thereby creating relevant developer error information; automatically informing developers about the relevant developer error information; generating, by the developer, a second version of the software module based on the previous software version and the relevant developer error information; and repeating the steps of evaluating all possible messages and establishing the messages as evaluation criteria for the second version of the software module.

Advantageously, the system provides time savings via an automatic evaluation of a large set of log files with minimal manual intervention. A precision analysis can be performed by implementing a uniform evaluation of the log files in the field, at a testing center, in the supply chain management, and in a development environment. Furthermore, a larger statistical basis can be utilized than when the log files are evaluated manually.

The automatic evaluation further permits a proactive error recognition at the customer's site, allowing errors in their systems to be detected and remedied before they lead to a disruption of the customer's processes. Furthermore, the automatic evaluation permits a more precise error recognition before the delivery of a system to a production environment. Systems are allowed to be delivered only when the stress test was successful and no serious errors have occurred.

The automatic evaluation further permits remote diagnosis of problems, which supports developers in the systematic error search. This also permits a quality comparison to be made of different software versions, and allows calculated indices to serve as a decision basis for releasing system software. These calculated indices can serve as a decision basis for worldwide software updates. Furthermore, targeted upgrades can be planned and implemented based on a statistically relevant number of automatically monitored systems.

Further advantages include a transparency of errors for all participants in system projects. Via structured error assessment and representation of the errors, the causes can be precisely recognized and necessary measures can be taken on the basis of identical evaluation criteria. The improvement in the quality of system software results in satisfied customers and cost savings. Since the error analysis is performed more quickly, the customer experiences less down time and higher utilization of their systems. Furthermore, a more accurate determination as to whether a technician visit is necessary can be ascertained by this error analysis. In the system, an objective is to provide easy access to source data.

As used herein, an event log file (log file) is a file which contains Events created by a software system, such as Siemens' AXIOM Artis System.® A result file is a file which contains a filtered number of events from a log file created by the system. An event is a message in the event log file. A search pattern is a pattern with which an analysis tool and supporting algorithms filter irrelevant event logs.

### DESCRIPTION OF THE DRAWINGS

The invention can be illustrated below with reference to a preferred embodiment illustrated in the drawings and appertaining following descriptive text.

FIG. 1 is a flow diagram illustrating the flow of processes in the system;

FIG. 2 is a screen shot of a results display; and

FIGS. 3A-D are further screen shots of the different levels of the results display.

### DETAILED DESCRIPTION OF THE PREFERRED EMBODIMENTS

The present invention is illustrated using an example of a preferred embodiment in which an x-ray system serves as the system being analyzed. Such an x-ray system may be installed at a customer or client's location, in the supply chain management or could be used in a development laboratory in order to further develop the x-ray system.

In such systems, a library of potential messages (“mc files”) that can be found in log files can be directly extracted from the source code that was used to design the system. Such source code comprises all potential possible error messages that can be reported by the various systems and written into log files. These serve as a basis for an assessment or evaluation and, depending on the system state, can provide an indication as to the nature of the error, i.e., serious, trivial, or none.

Furthermore, system states, which comprise all states in which e.g., an x-ray system can be found (for example, examination, boot, shutdown, service, SW installation, etc.), can be used as a part of the analysis. These are begun via messages and ended via messages or other temporal or logical dependencies. The system states define the boundary conditions according to which the tool decides whether a message is assessed as an event or not. Logical links between system states are possible (e.g., include, exclude, threshold, set dependencies, etc.). Events relate to the occurrence of specific messages within specific system states.

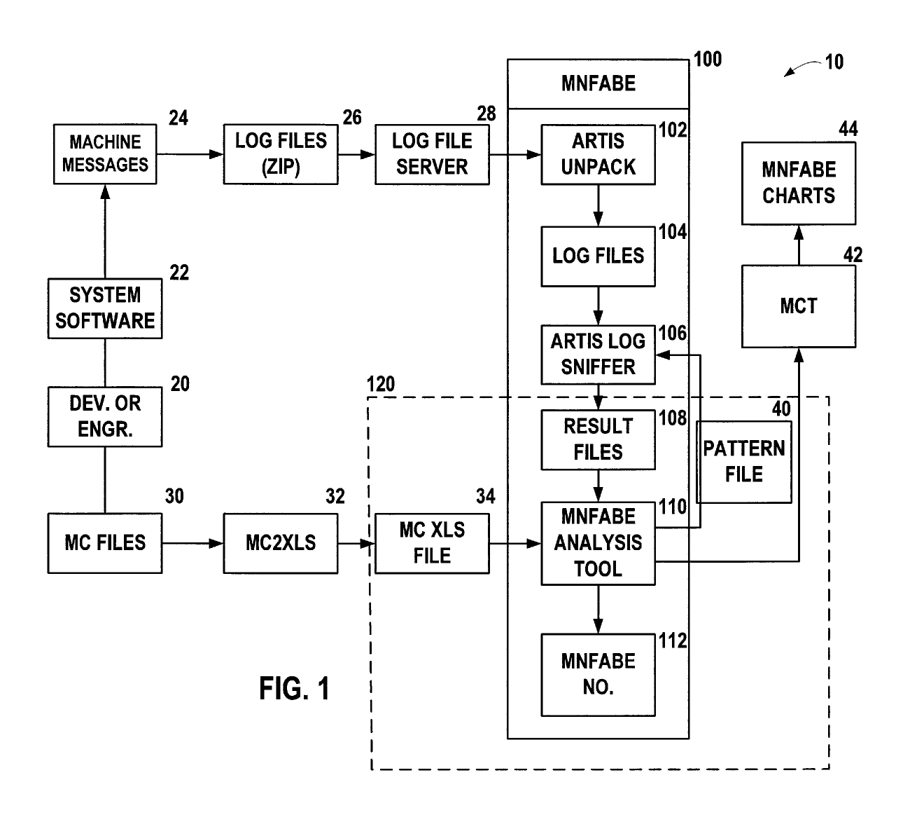

FIG. 1 illustrates a flow chart overview for the analysis in an exemplary system 10 that determines a Mean Number of Fluoros and Acquisitions Between Events (MNFABE). Developers and engineers 20 create a system software module 22 that is designed to operate within the context of an operation system—in the present exemplary situation, an x-ray system.

In a preliminary stage, a library of potential messages, mc files 30, are extracted from the system software 22 with all potential error messages from the corresponding parts of the system software 22 of the x-ray systems. These mc files 30 are processed into a standard format 32 that is suitable for analysis, such as a Microsoft Excel® file 34. This file or files are generated for all components that comprise all possible error messages in the system. During the processing, all potential error messages in all possible system states of the x-ray systems are evaluated; a differentiation is made between serious and trivial errors and other messages. The standard format mc-xls file 34 is imported into the MNFABE analysis tool 110 as a basis for the subsequent automated evaluation. The dotted-line box 120 indicates the analysis tool 110 with it appertaining interfaces.

Events and errors may be classified as Type-1 and Type-2 events. A Type-1 event is the occurrence of a problem, which disturbs the workflow during a physical examination, and a Type-2 event is the occurrence of a problem, which does not disturb the workflow of the physical examination.

During operation of the system software 22, relevant error and status messages/events 24 originating from the system software 22 are collected and/or compressed into log files 26. The compression can use any well-known compression algorithm, such as that used by the well-known ZIP utility. These compressed files 26 are sent to a log file server 28. The transfer of files to the server 28 can occur on some periodic basis (e.g., daily).

For the analyses, the MNFABE analysis tool chain 100 comprises a procedure for unpacking of files 102 according to predetermined scheme—illustrated is an exemplary scheme related to Siemens' AXIOM Artis™ family of products (Artis Unpack 102). The files are unpacked 102 into the log files 104 into an area (the Artis log sniffer 106) in which the MNFABE analysis tool 110 can evaluate the log files.

On the basis of defined search patterns 40, the log files 104 are searched through by the Artis log sniffer 106, which filters relevant events out and places them in result files 108. These result files 108 are the basis for operation of the tool 110. Due to performance and ease of use, the data of the result files 108 may be stored in an SQL database for ease of use (although any other storage mechanism may be utilized), which a source of data for the analysis tool 110.

The logic of the evaluation within the tools may be performed according to predetermined criteria. Presentation of indices and possibility of detailed filtering for error analysis can be performed, and a generation of a graphical evaluation, such as MNFABE charts 44, can be created with regard to the individual software versions 108. Additionally, reports can be generated, including chronological reports.

An export of pattern files 40 as a basis for the compression of data may be provided as a foundation for the process. In order to create new search patterns 40 for the correct filtering of events by the Artis log sniffer 106, a kind of “pattern flow” may be utilized. Based on results of the analysis tool 110, the developers and engineers 20 update and improve the system software 22 of the products. New pattern files (mc files) 30 have to be created or existing files have to be updated. These files will be transformed into a special format (mc-xls file) 34 for the tool 110 by a software the mc2xls 32 component. Finally, based on these files 34 the tool 110 creates a new pattern file 40 used by the Artis log sniffer 106.

It should be noted that the analysis tool 100 could be implemented as an internal web application, but could also be implemented as any form of dedicated application and possibly in any form of a client-server architecture.

The tool 110 can automatically calculate relevant figures for Type 1 and Type 2 events. As an output, one of the values provided by the tool 110 is a number that represents some form of system parameter based on the number of events. As illustrated in FIG. 1, an MNFABE number 112 is produced by the tool 110. This number may be calculated, e.g., by the numbers of fluoroscopy imagings (fluoros) and acquisitions divided by the numbers of events. A division by zero returns the simple number of fluoros and acquisitions. This tool 110 further can produce the charts 44 using a chart tool component 42.

An aspect of the invention is that, for the workflow, all persons who are necessary for error correction or improvement of software versions on the system are integrated into the workflow as well. Those responsible for components may be informed via, e.g., e-mail as soon as an error occurs in a component in their area of responsibility. Moreover, display mechanisms can indicate in an overview where problems arise for evaluation. The entire workflow can thereby be surveyed and the responsible person recognizes exactly where his attention is required. Error recognition and measures are documented for the respective system and, if applicable, are linked with an error correction in problem solving tools. Possible necessary measures and responses may be provided in the form of comments from the field. All workflow steps are documented with the user's account and a timestamp in an audit trail.

Advantageously, in the system 10, all messages that can occur in log files of the various systems are beforehand systematically evaluated and established as evaluation criteria in the development phase of the system software. Given use of these systems in the development labs and at customers, the transferred log files are evaluated automatically using the defined evaluation criteria.

The system developers 20 are automatically informed about errors that have occurred, and are supported in the search for errors via a structured overhaul of the data in the search for causes of error. The knowledge thereby acquired enter into the definition of new or altered requirements for the system software and messages for improved error recognition in the system software. The control loop itself is implemented in a completely automated manner. Various aspects of the functionality of the tool 110 can be controlled via access rights.

In an embodiment of the invention, an initial display screen is presented to the user that permits access to various field logs of different clients (e.g., developer, test center, supply chain management, and field), with an illustration, by software version number, of the MNFABE number 112 by Type. Additional analysis status information can be provided, such as the number of result files, number of relevant events, an import queue, parser performance (e.g., in lines/sec.) and reclassified events.

A client represents a group of users who use the tool 110 in different product phases. There are 4 different clients available: the field client for evaluating and processing of events that occurred at systems which are located at customers; the supply chain management client for evaluating and processing of events that occurred at systems which are located at the production site; the test center client for evaluating and processing of events that occurred at systems which are located at the test center; and the developer client for evaluating and processing of events that occurred at systems which are in the development phase.

A version number for software may include both a version sequence number (“VB30C”) and a release date (“041906”). The segregation according to Type of event could be provided in a table shown on the display, where the MNFABE number 112 could be provided. For example, under the Type-1 event, a number of 3764 might indicate that for this particular version of software, 3746 fluoros and acquisitions could be done on average before a Type-1 event occurs.

Detailed information regarding the events can be provided on the display in a result view, including the source of the events or other activity as they related to the various software module versions, along with relevant summary information. A filter may be applied so that only those events that match the filter criteria are displayed. The filtering permits one to restrict the event display via special filter options. For example, one can restrict the display based on defining a period of time, with a mechanism for entering the start and stop times, along with utilities for easily adjusting these times, such as by adding or removing a day. A default value, such as three months from today, can be utilized, and this value can be adjusted in administrative settings or in application initialization files.

The filtering can further be done by software module and version, system type, serial numbers (that are unique to a system), and processing status (T1 events, changed to T2 by user, changed to T2 by parser, ignored by user, ignored by parser, and remaining (manual MNFABE)). The T1 events and remaining could be chosen as a default. Combinations of these events could be selected, where practical.

The filter options determine which events are displayed in the results view, and which events are included in the report calculations. Multiple result files 108 can be created and displayed, printed, and exported. A Report and Audit function may also be provided in the results view.

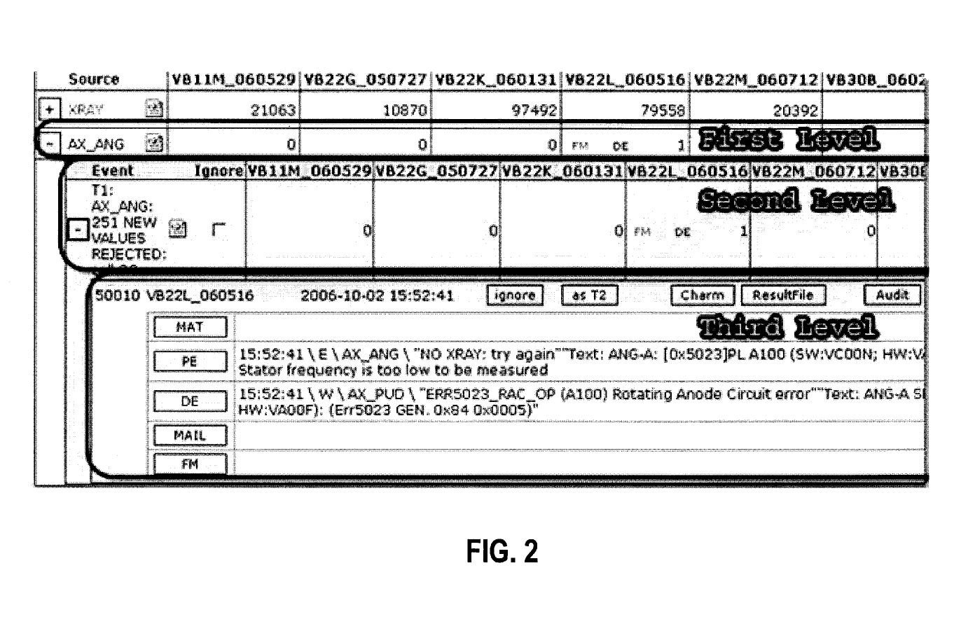

An illustrative exemplary result view is shown in FIG. 2. The result view is composed of different levels of details. The higher the level of detail, the more information about an Event of certain component will be displayed.

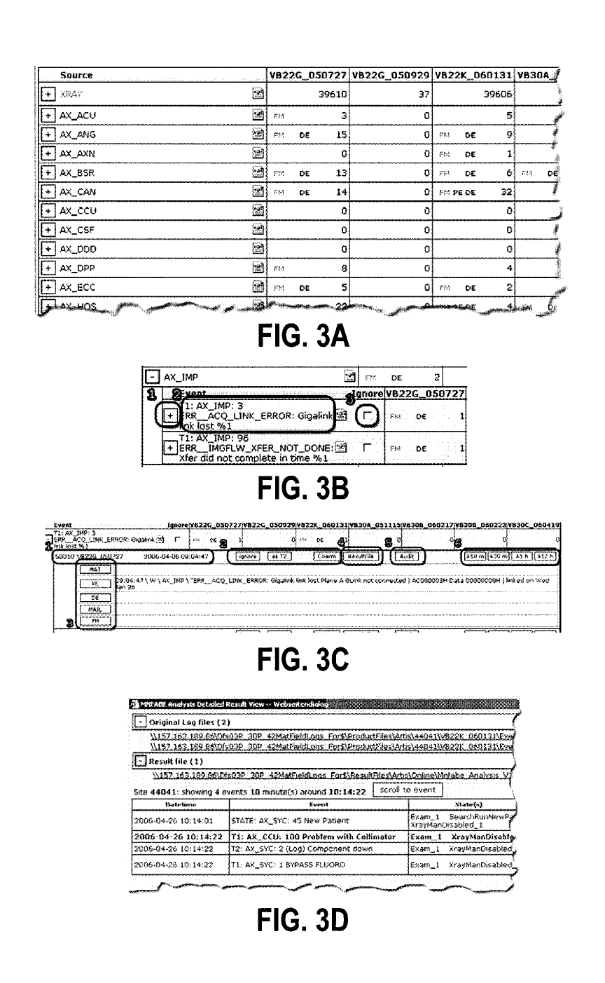

Referring to FIGS. 3A-D in the following, for a first level of detail (FIG. 3A), events in the result view are itemized and displayed in a table. Vertically, the events may be assigned to the respective components of the system (source), which triggered the event. Horizontally, the events have been assigned to the different software versions. For example, the “AX_ANG component” gives a number of T1 (T2) Events, for the different software versions.

The “XRAY events” give a number of fluoros and acquisitions for the different software versions. The user may select a display element to get more details of a component (see “second level of detail”); a component name may be provided, and selecting a symbol, e.g., “reports”, can be used to generate a report overview of the current filtered events.

The report may be generated as an HTML page that can be saved, printed, sent to another user, etc. Symbols may mark “To Do's” for events that are still in process. For example, “FM” may mean, that there are still open issues for the field measure, “PM” may mean that there are still open issues for the Primary Evaluator, and “DE” may mean that there are still open issues for the Developer. Furthermore, a number of events of a special component and a corresponding software version may further be shown.

In the second level of detail (FIG. 3B), a more detailed view can be displayed. The events of a component are more specified in this level. A display element (e.g., “+”) can be selected to get more details of an event “category” (see “third level of detail” below).

In the third level of detail (FIG. 3C), event information can be shown, including the serial number of the system which triggered the event, the software version that is installed on the system, and a time-stamp of the event, functions for processing of the event (see “Processing of Events”), buttons to open the comment editor (see “Processing of Events”), a Result File:

Executing the “Result File” opens with a text editor the corresponding result file the event is located; depending on the settings in the Administration and user's rights, analysis tool tries to open the Result File with an editor that can display and highlight the corresponding event directly. Furthermore, and audit function with functions to retrace all changes, made on the corresponding event. Events can be shown, which have occurred shortly before and shortly after the considering event. The period of time around the event can be selected: e.g., +/−10 minutes, +/−30 minutes, +/−1 hour, +/−12 hours (FIG. 3D). Moreover, the display can also show links to the corresponding result file(s) and original log file(s), in which the event is located.

The events may be processed in a number of ways. For example, a comment editor may be utilized to comment on events. The comment editor may be implemented as a dialogue entry box in which a corresponding agent inserts a comment to the occurred event. The relevant agents include: (PE) Primary evaluator; (DE) Developer; and (FM) Field measure. Various indicators could be provided to show whether a comment has been inserted or not, and entry of a comment can be restricted to different fields by system permissions. Comment edits may be saved, finished, cancelled, deleted, and e-mailed to other users of the tool (relevant data can be included, and the e-mail recipients can be selected from, e.g., a list. Moreover an event could be assigned to another component. In this case the responsible developer of the new component would be informed about the event automatically.

An event can be ignored if the user knows that it is not a correct event and should not be counted. An entry mechanism, e.g., a pop-up window, may be provided in which the user can enter the ignore reason. Furthermore, the window can show other ignored events, which are dependent on the current event. An event can be changed as well. For example one can click on a button to have an event not counted as T1 (T2) event but as a T2 (T1).

Data sets can be operated on, and the operations that can be performed may be based on access privileges. For example, administrator level users may be able to perform functions that differ from those of ordinary level users. Various operations may be performed on data sets. To modify a data set, one may simply have to overwrite an existing input field or supplement existing data. In an embodiment of the invention the modifications are accepted at once and do not need to be saved explicitly.

Data sets can be created by, e.g., filling out a field of the table and saving the data set by clicking on an icon, triggering the stored data set to be added to the existing data sets. Data sets can be cleared by interacting with the appropriate user interface element. A data set may further be copied so that it can be used as a template. Navigation through the data sets can be performed by using, e.g., a mouse wheel or navigation bar.

For compliance with certain quality requirements, a logbook may be kept for each data set, enabling one to retrace any changes to a data set. In the audit window, the actions performed may be listed together with the corresponding time and the performing person. In addition, the changed fields can be listed with the old and the new value.

The tool can assign every event to a certain system type that triggered it. The assignment can be done using the serial number of the system type, which is included in every event. The serial number ranges of the system types can be determined and administrated. If a serial number range of a system type is changed or if a new system type is added, the corresponding ranges can be determined.

A user can be assigned to different system components that he is responsible for. If a system component causes a failure, the users assigned to this component can be notified by email. Automatic e-mail notifications can be configured following the occurrence of various events. For example, a user can chose whether they wish to receive a notification to their registered email address in case of a T1 or T2 event. A user can chose a starting time of email notification; and a time period (days/hours/seconds), after which a repeated notification can be sent at the earliest time.

Global preferences and general settings may be set, such as the path to external tools and directories or settings for evaluation of characteristics. Since these settings are rarely changed and a short description for each setting is available, there is no need for a detailed description. A configuration backup enables a backup of the current configuration settings of the administration level as well as the retrieval of previous settings. A database backup permits a complete backup of the current tool.

A configuration process may be used to create and list basic software versions that are installed on the systems. A folder may be created into which data is copied. E.g. in the directory M:\AX\03_Projects\30_PLM\

41_MAT TestCenter_FOR\ConfigFiles\Artis\ArtisLogSniffer\P atternFiles\, one creates a new directory for the new version (e.g. . . . \VB30c), e.g. using the Windows Explorer. Then, pattern files may be copied into the new directory (using patterns of the previous version). Thus, according to the example, in the directory M:\AX\03_Projects\30_PLM\

41_MAT_TestCenter_FOR\ConfigFiles\Artis\ArtisUnpack\

JobFiles\ also create a new directory for the new version, e.g. using the Windows Explorer.

A job file may be copied into the new directory (use Job File of the previous version). The correct System Version and Pattern Version can be entered in the Job File using, e.g., a text editor. The tool is then used to create a software version. Information related to the new software version (e.g., Ident String, Description, Release Date) is entered and saved. System states and search patterns of a previous version may be copied for utilization by the current version, possibly with some modifications.

An MC_Import function may be implemented. For this, the user selects a software version that the data (e.g., Excel) files are to be imported for. A directory of the software version from which the user wishes to import the files from is selected, as are the files of the corresponding components (source).

For each basic software version there may be several sub-software versions that are created and administrated. The process is essentially the same, with the exception that there is a new hierarchical structure in place to deal with the sub-software versions, and the versions are selected prior to selecting the sub-versions.

A “pattern” link of a sub-software version may be created and the user can retrieve a list of the assigned search patterns, which can be activated or de-activated. A “states” link of a sub-software version can list the system states assigned to the version. One can similarly activate or de-activate states.

A results file inventory can also be provided that lists all imported result files that were imported into the tool, which can include the site (serial number of the system), system type, installed software version, file name of the result file, time that the result file was imported. A delete function can be provided that deletes the result file and the imported data. The data can also be refreshed on the display.

An import tool may be provided that constantly reads out result files that were generated by the Artis log sniffer and writes this data into the tool data base. A job queue shows the current process status of the import process, and can include the time of result file creation, complete path information for the file, the time that the import was started, the time that it was completed, the number of parsed lines of the result file, and a process status indicator. A delete function can be provided to delete any imported data up to a point in time, and a flush database function can be provided to delete the entire database.

A MC_import function can be provided to create new basic software versions, and a download pattern file function can be used to create a single pattern file that can be stored separately. The pattern files created by the download pattern file function are the basis for the Artis log sniffer. There is one pattern file for every component of every software version.

Any of the systems or components described herein may be implemented on any general purpose computer or computers and the components may be implemented as dedicated applications or in client-server architectures, including a web-based architecture. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions executable on the processor on media such as tape, CD-ROM, etc., where this media can be read by the computer, stored in the memory, and executed by the processor.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, C#, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for automatically evaluating a log file of a software module, comprising:
prior to an execution of a first version of a software module:
evaluating all possible messages or events that can occur in a log file of the first version of the software module; and
establishing the messages or events as evaluation criteria for a further development phase of the software module;
during execution of the first version of the software module:
generating a log file comprising a plurality of message or events from the software module; and
after generation of the log file:
transferring the log file to an analysis system;
automatically evaluating the plurality of messages or events in the transferred log file according to the previously established evaluation criteria, thereby creating relevant developer error information;
automatically informing developers about the relevant developer error information;
generating, by the developer, a second version of the software module based on the previous software version and the relevant developer error information; and
repeating the steps of evaluating all possible messages and establishing the messages as evaluation criteria for the second version of the software module.

2. The method according to claim 1, wherein the software module is a module utilized for a medical imaging system.

3. The method according to claim 1, wherein evaluating all possible messages or events comprises extracting the messages or events from source code used to design the software module.

4. The method according to claim 1, further comprising classifying the messages or events as being serious, trivial, or none in terms of degree of seriousness.

5. The method according to claim 1, further comprising classifying the messages or events as being a Type-1 event that represents an occurrence of a problem which disturbs the workflow during a physical examination, and a Type-2 event that represents the occurrence of a problem, which does not disturb the workflow of the physical examination.

6. The method according to claim 5, further comprising calculating relevant figures per Type-1 and Type-2 events.

7. The method according to claim 1, wherein the log file is stored as a spreadsheet file.

8. The method according to claim 1, wherein the log files is subject to a compression algorithm prior to storage.

9. The method according to claim 1, wherein the transferring of the log file occurs on a periodic basis according to a predefined criteria.

10. The method according to claim 1, where automatically informing developers comprises creating an evaluation with regard to individual software versions for developers.

11. The method according to claim 1, further comprising planning and implementing upgrades based on a statistically relevant number of automatically monitored systems.

12. The method according to claim 1, wherein the generated log file further comprises information on system states.

13. The method according to claim 12, wherein the system states comprise a state selected from the group consisting of: examination, boot, shutdown, service and software installation.

14. The method according to claim 1, wherein the software versions are installed in a field setting, at a testing center, in a supply chain management setting, and in a development environment.

15. The method according to claim 1, further comprising transmitting the generated message or event to an individual responsible for a component that generated the message or area.

16. The method according to claim 1, further comprising calculating a number based on a number of events occurring.

17. The method according to claim 16, wherein the number is based on a number of fluoroscopy imagings and acquisitions divided by a number of events.

18. The method according to claim 1, further comprising filtering the events or messages in the transferred log file according to a predefined criteria and placing the filtered events or messages into a result file.

19. The method according to claim 18, wherein the result file is stored in an SQL database.

20. The method according to claim 18, further comprising utilizing predefined pattern files for the filtering.
